(19) United States
(12) Patent Application Publication
(10) Pub. No.: US 2014/0137743 A1
(43) Pub. Date: May 22, 2014

(54) ACTIVATED CARBON AIR FILTER HAVING A CONICAL INNER CAGE

(71) Applicant: PRIMA KLIMA TRADING CZ S.R.O., Radnice u Rokycany (CZ)

(72) Inventor: Gerhard REEH, Radnice u Rokycany (CZ)

(73) Assignee: PRIMA KLIMA TRADING CZ S.R.O., Radnice u Rokycany (CZ)

(21) Appl. No.: 14/083,505

(22) Filed: Nov. 19, 2013

(30) Foreign Application Priority Data
Nov. 21, 2012 (DE) 202012011149U1

(51) Int. Cl. B01D 53/04

(52) U.S. Cl. CPC B01D 53/0415; B01D 53/0446
USPC 96/151; 96/152; 29/428; 29/525.06

(57) ABSTRACT

A filter cartridge for cleaning air includes a perforated sheet metal outer cage having a cylindrical shape, the diameter thereof being the same over the entire length of the filter cartridge, a base disc closing off the lower end of the filter cartridge, and an inlet fitting closing off the upper end. The filter cartridge includes a conical perforated sheet metal inner cage extending from the base disc to the inlet fitting in the interior of the perforated sheet metal outer cage. The perforated sheet metal inner cage tapers down conically in the direction from the base disc to the inlet fitting, wherein the diameter of the perforated sheet metal inner cage decreases from the base disc to the inlet fitting. The filter cartridge further includes an activated carbon layer disposed in the intermediate space between the perforated sheet metal inner cage and the perforated sheet metal outer cage.

The invention relates to a filter cartridge for cleaning air and a filter device for cleaning air. The invention further relates to a method for assembling a filter cartridge designed for cleaning air.

Activated carbon filters for cleaning air have proven themselves in many embodiments. In many cases, however, the filter cartridge is not uniformly permeated with air.

The object of the invention is to provide a filter cartridge for cleaning air that allows uniform air flow.

Said object is achieved by a filter cartridge for cleaning air according to claim 1, by a filter device for cleaning air according to claim 10, and by a method for assembling a filter cartridge according to claim 15.

A filter cartridge according to the embodiments of the invention serves for cleaning air and comprises a perforated sheet metal outer cage having a cylindrical shape, the diameter thereof being the same over the entire length of the filter cartridge, a base disc closing off the lower end of the filter cartridge, and an inlet fitting closing off the upper end of the filter cartridge. The filter cartridge comprises a conical perforated sheet metal inner cage extending from the base disc to the inlet fitting in the interior of the perforated sheet metal outer cage and being held in place by the base disc and the inlet fitting. The perforated sheet metal inner cage tapers down conically in the direction from the base disc to the inlet fitting, wherein the diameter of the perforated sheet metal inner cage decreases from the base disc to the inlet fitting. The filter cartridge further comprises an activated carbon layer disposed in the intermediate space between the perforated sheet metal inner cage and the perforated sheet metal outer cage, wherein the thickness of the activated carbon layer diminishes in the direction from the inlet fitting to the base disc due to the cylindrical shape of the perforated sheet metal outer cage and the conical shape of the perforated sheet metal inner cage.

A filter cartridge according to the embodiments of the invention has the advantage that, due to the decreasing thickness of the activated carbon layer from the inlet fitting to the base disc, uniform permeation of the activated carbon layer is achieved. The filter cartridge allows uniform airflow along the entire filter surface. This means that the activated carbon is uniformly loaded with contaminants. In addition, the filter cartridge allows quick assembly and disassembly and can be refilled.

The invention is further described below using an embodiment example shown in the drawing. They show:

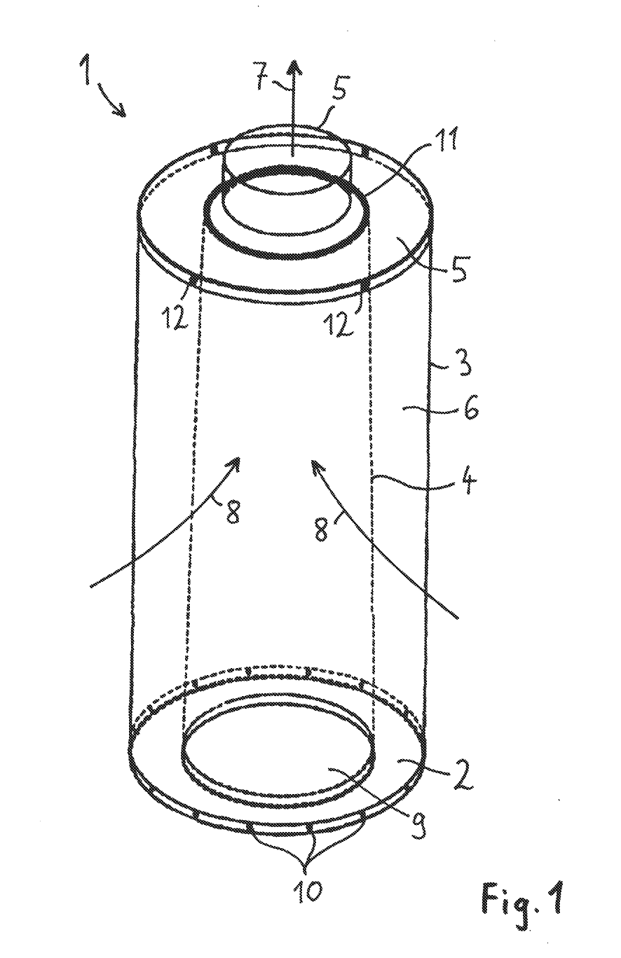

FIG. 1 an overview of an activated carbon filter cartridge;

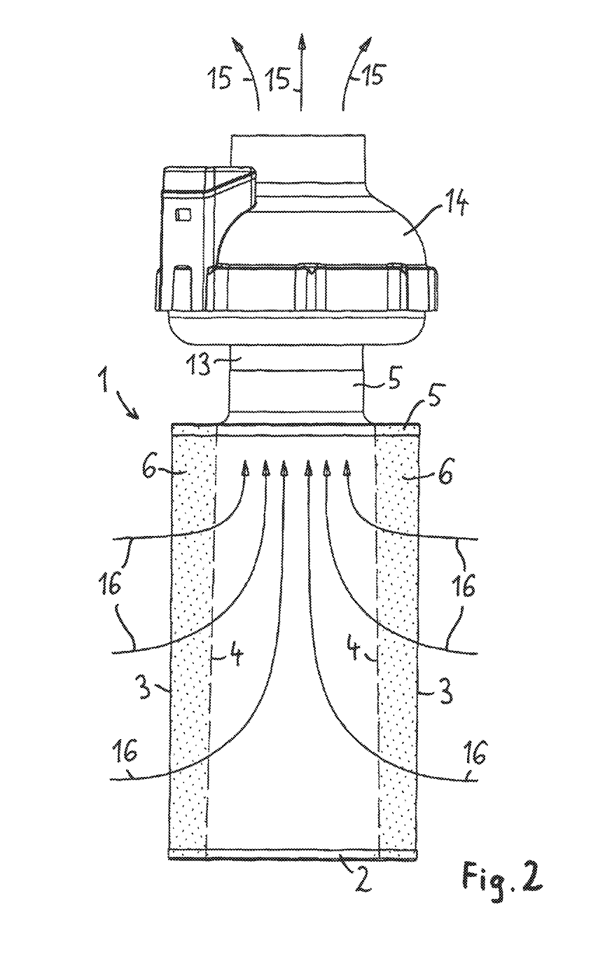

FIG. 2 an activated carbon filter cartridge connected to an exhaust blower when is running;

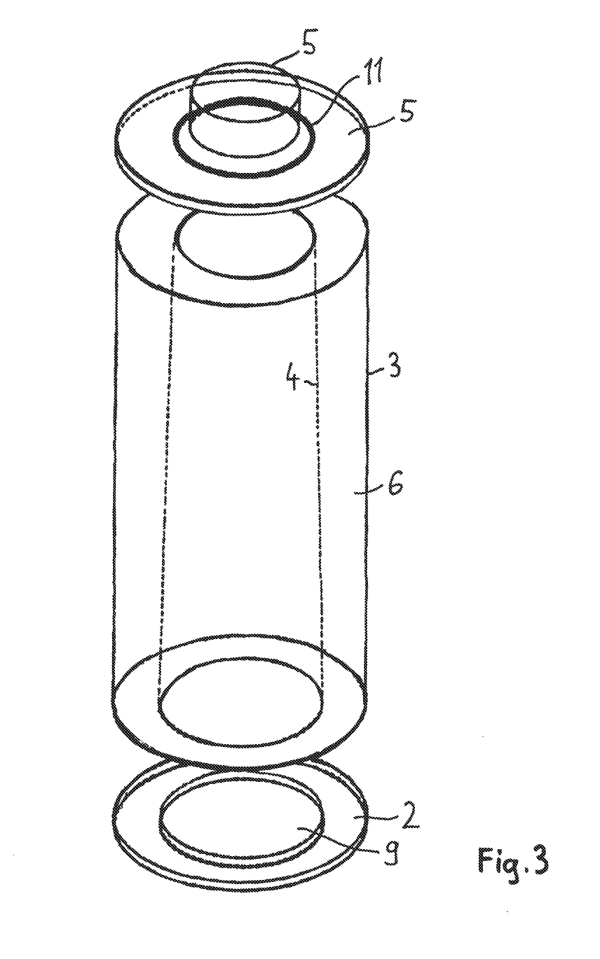

FIG. 3 an exploded view drawing depicting the construction of the activated carbon filter cartridge;

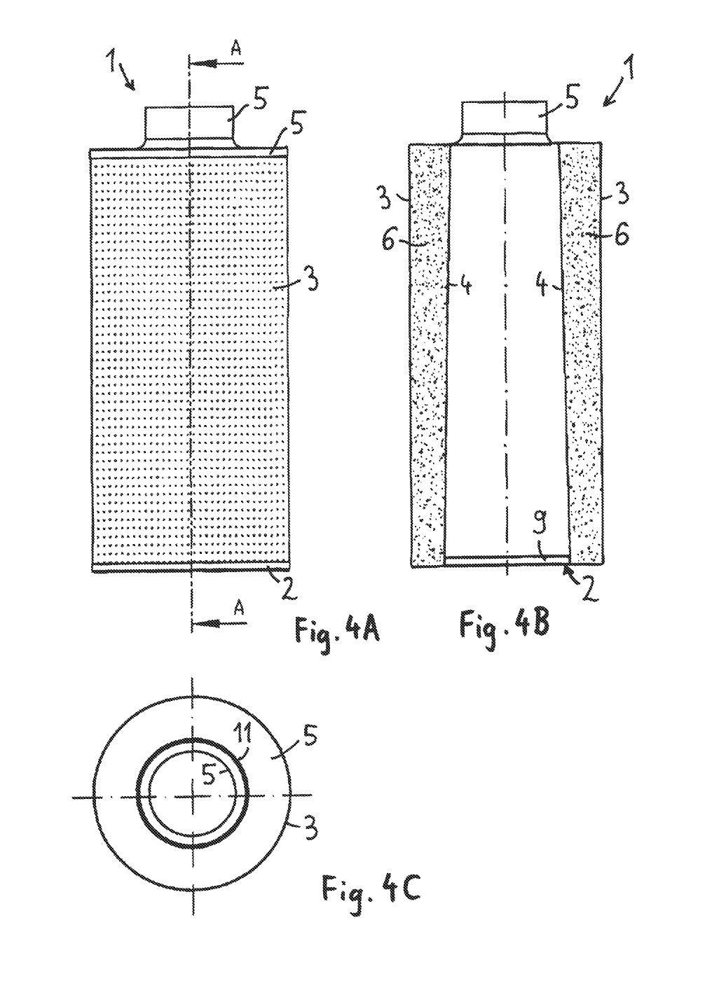

FIG. 4A a side view of the activated carbon filter cartridge;

FIG. 4B a section view of the activated carbon filter cartridge;

FIG. 4C a plan view of the activated carbon filter cartridge; and

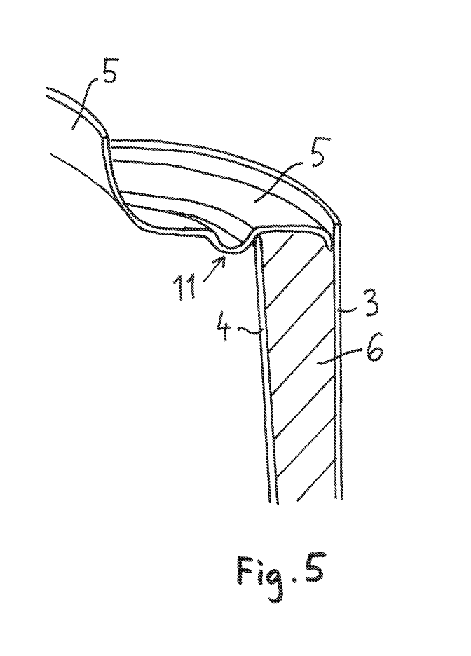

FIG. 5 a detail view depicting how the inner cage of the activated carbon filter cartridge is held in place by the circular peripheral groove disposed on the inlet fitting.

FIG. 1 shows an activated carbon filter cartridge according to the embodiments of the present inventions and used for cleaning air. The activated carbon filter cartridge can be used for cleaning kitchen vapors, for example, as well as for cleaning the air in painting facilities, butcher shops, toilets, animal pens, the pet food industry, etc. in general, the activated carbon filter cartridge can be used wherever undesired odors and air pollution occur.

The activated carbon filter cartridge 1 shown in FIG. 1 comprises a base disc 2, an air-permeable outer cage 3 having a cylindrical shape, an air-permeable inner cage 4 tapering down from the bottom to the top, and an inlet fitting 5. The outer cage 3 is preferably implemented as a perforated sheet metal outer cage and the inner cage 4 is preferably implemented as a perforated sheet metal inner cage. As is known to a person skilled in the art, expanded sheet metal can be used in place of perforated sheet metal. Both the outer cage 3 and the inner cage 4 can also be made of expanded sheet metal. Expanded sheet metal is produced by making offset cuts in sheet metal while simultaneously stretching the sheet metal.

The activated carbon particles for cleaning the air are poured into the annular circumferential intermediate space between the inner cage 4 and the outer cage 3. An annular circumferential activated carbon layer 6 is thus produced between the inner cage 4 and the outer cage 3.

The inlet fitting 5 is connected to the air inlet of a fan or a suction blower for cleaning contaminated air. The air is thereby drawn out of the interior of the activated carbon filter cartridge, as is shown by the arrow 7 in FIG. 1 To maintain equilibrium, air flows in from outside in the direction of the arrow 8, through the activated carbon layer 6, and into the interior of the air filter cartridge. The air is thereby cleaned as it permeates the activated carbon layer 6 and the unpleasant odors are absorbed by the activated carbon particles of the activated carbon layer 6. Cleaning of the permeating air is achieved in this manner.

The circular base disc 2 typically comprises a diameter in the range from 15 cm to 30 cm, such as a diameter of about 23 cm. The base disc 2 is preferably a metal part. The base disc 2 is preferably a formed metal part. The formed metal part is preferably given the desired form using metalforming techniques, such as by means of a high-performance spinning machine.

The base disc 2 comprises a raised dome 9 in the center having a diameter corresponding approximately to the diameter at the lower end of the inner cage 4. The raised dome 9 serves to retain the inner cage 4, the lower end of which is placed on the raised dome 9. The raised dome 9 can preferably be produced by deep drawing. The base disc 2 is connected to the lower end of the outer cage 3 by means of a plurality of spot welds 10.

The outer cage 3 typically comprises a diameter in the range from 15 cm to 30 cm, such as a diameter of about 23 cm. The outer cage 3 typically comprises a length in the range from 30 cm to 60 cm, such as a length of about 50 cm. The outer cage 3 comprises a cylindrical shape and the diameter thereof is constant over the entire length.

The inner cage 4, in contrast, comprises a conical shape. The diameter of the inner cage 4 diminishes continuously from the base disc 2 to the inlet fitting 5. The diameter at the lower end of the inner cage 4 is thus somewhat larger than the diameter at the upper end of the inner cage 4. The length of the inner cage 3 corresponds approximately to the length of the outer cage 3.

Due to the conically tapering shape of the inner cage 4, the thickness of the activated carbon layer 6 diminishes continuously from the inlet 5 toward the base disc 2. The thickness of the activated carbon layer 6 is thus greatest in the region of the inlet fitting 5. For example, the activated carbon layer 6 can have a thickness of about 5 cm in the region of the inlet fitting 5, while the thickness in the region of the base disc 2 can be about 4 cm.

The inlet fitting 5 is implemented as a cover for the activated carbon filter cartridge 1. The inlet fitting 5 is preferably a metal part. The inlet fitting 5 is preferably a formed metal part. The formed metal part is preferably given the desired form using metalforming techniques, such as by means of a high-performance spinning machine.

The inlet fitting 5 comprises a circular circumferential groove 11, the diameter thereof corresponding approximately to the diameter at the upper end of the inner cage 4. The upper end of the inner cage 4 can thereby be slid or placed over the circumferential groove 11, wherein the upper end of the inner cage 4 is held in place by the circumferential groove 11.

The inner cage 4 is thus supported at the lower end by the raised dome 9 and at the upper end by the circumferential groove 11. This free-floating mounting of the inner cage 4 in the interior of the activated carbon filter cartridge makes it possible to assemble and disassemble the activated carbon filter cartridge in a simple manner. The connection between the upper end of the outer cage 3 and the inlet fitting 5 is preferably produced by means of a plurality of blind rivets 12.

The mode of operation of an activated carbon cage filter according to the embodiments of the present invention is shown in FIG. 2. The inlet fitting 5 of the activated carbon filter cartridge 1 is attached to the air inlet 13 of a suction blower 14. When the suction blower 14 is switched on, air is transported from the interior of the activated carbon filter cartridge 1 via the inlet fitting 5 and the air inlet 13 to the outside, as is shown by the arrows 15, The interior of the activated carbon filter cartridge 1 is thus at a low pressure. In order to compensate for this low pressure, air flows from the outside through the activated carbon layer 6 from all sides into the interior of the activated carbon filter cartridge 1. This is shown in FIG. 2 by the arrows 16. When permeating the activated carbon layer 6, the air is cleaned of pollutants and odors.

Low pressure is produced in the interior of the activated carbon filter cartridge 1 by the suction blower 14. This low pressure is particularly strong in the region directly below the inlet fitting 5. Due to the air flowing in from outside, the low pressure diminishes continuously in the direction toward the base disc 2. In the region below the inlet fitting 5, the low pressure is significantly more severe than in the region above the base disc 2, so that a pressure gradient is formed in the direction from the inlet fitting 5 to the base disc 2 during continuous operation. The pressure differential between the interior and exterior of the activated carbon filter cartridge 1 is greatest below the inlet fitting 5 and least in the region above the base disc 2.

Said pressure gradient occurring in the interior of the activated carbon filter cartridge 1 is accommodated for the activated carbon filter cartridge 1 by the conically decreasing shape of the inner cage 4. The inner cage 4 tapers down in the direction from the base disc 2 to the inlet fitting 5. In the region of the base disc 2, the diameter of the inner cage 4 is greater than in the region of the inlet fitting 5. The diameter of the outer cage 3, in contrast, is constant over the entire length of the activated carbon filter cartridge 1.

Due to the conical shape of the inner cage 3, the thickness of the activated carbon layer 6 diminishes continuously from the inlet fitting 5 toward the base disc 2. In the region below the inlet fitting 5, a quite severe low pressure is produced. The thickness of the activated carbon layer 6 is thus greatest here. In the region below the inlet fitting 5, the activated carbon layer 6 can be about 5 cm thick, for example.

The thickness of the activated carbon layer 6 becomes less and less in the direction toward the base disc 2. The region above the base disc 2 is far away from the inlet fitting 5, and thus only a slight low pressure is produced here. The thickness of the activated carbon layer 6 is accordingly least in the region above the base disc 2. In the region above the base disc 2, for example, the activated carbon layer 6 can be about 4 cm thick.

For the activated carbon filter cartridge 1 according to the embodiments of the present invention, the thickness of the activated carbon layer 6 is thus varied according to the pressure gradient that is generated. The greater the difference in pressure between the interior and exterior, the thicker the activated carbon layer 6 to be permeated by the air is implemented.

In the region below the inlet fitting 5, the low pressure generated by the suction blower 14 is most severe, and the pressure differential between the inner and outer chambers of the activated carbon filter cartridge 1 is relatively large. Accommodating the high pressure difference, the thickness of the activated carbon layer 6 to be permeated is selected to be relatively large in the region below the inlet fitting 5.

The low pressure decreases continuously in the direction toward the base disc 2 due to the inflowing air. In the region above the base disc 2, the low pressure is only relatively weak and the pressure differential between the interior and exterior is relatively low. Accommodating the relatively low pressure differential between the interior and exterior, the thickness of the activated carbon layer 6 in the region of the base disc 2 is thus selected to be relatively low,

Due to the continuous reduction of the thickness of the activated carbon layer 6 from the inlet fitting 5 to the base disc 2, uniform permeation of the air over the entire surface of the activated carbon filter cartridge I is achieved. in the region. above the base disc 2, as well, where the low pressure generated by the suction blower 14 is no longer very strong, a sufficiently high airflow can still be achieved because the thickness of the activated carbon layer 6 in this region is selected to be correspondingly thin. The uniform permeation of the activated carbon layer 6 allows uniform air cleaning over the entire length of the activated carbon filter cartridge 1. The entire length of the activated carbon filter cartridge is used for cleaning the air flowing through the activated carbon layer 6. Due to the improved utilization of the entire activated carbon layer 6 over the entire length, the efficiency is improved relative to conventional solutions.

Due to the uniform permeation of the activated carbon layer 6 over the entire length of the activated carbon filter cartridge 1, more uniform loading of the activated carbon particles with pollutants and dirt is achieved than for conventional solutions. Due to the uniform airflow, both the activated carbon particles in the region of the inlet fitting 5 and the activated carbon particles in the region of the base disc 2 are uniformly loaded with pollutants and toxins. The cleaning capacity of the activated carbon particles can thus be optimally utilized over the entire length of the activated carbon filter cartridge 1. When the time comes that the activated carbon particles are severely contaminated and need to be changed out, the activated-carbon particles of the activated carbon layer 6 can be easily replaced with fresh and clean activated carbon particles.

A further advantage of the activated carbon filter cartridge 1 according to the embodiments of the present invention is the simple assembly that is shown in FIG. 3. When assembling the activated carbon filter cartridge 1, the cylindrically shaped outer cage 3 is first placed on or attached to the base disc 2. The mechanical connection between the base disc 2 and the lower end of the outer cage 3 can be secured by a plurality of spot welds, for example.

The wider end of the conically shaped inner cage 4 is then place on or attached to the raised dome 9 of the base disc 2. An annular circumferential intermediate space is formed between the outer cage 3 and the inner cage 4, into which activated carbon particles can be poured from above. An activated carbon layer 6 is formed in this manner between the outer cage 3 and the inner cage 4.

The inlet fitting 5 is then place on the upper end of the inner cage 4 and the outer cage 3. The annular groove 11 is formed on the underside of the inlet fitting 5. When placing the inlet fitting 5 on the inner cage 4 and the outer cage 3, the narrow end of the conically tapering inner cage 4 is slid onto the annular groove 11, wherein the upper end of the inner cage 4 is retained by the groove 11. In this respect the conically tapering inner cage 4 is held in place at the lower end by the raised dome 9 of the base disc 2 and at the upper end by the annular groove 11 of the inlet fitting 5. A mechanical connection between the upper edge of the outer cage 3 and the inlet fitting 5 is then formed by means of a plurality of blind rivets 12.

FIG. 4A through 4C show further views of the activated carbon filter cartridge 1. FIG. 4A shows a side view of the activated carbon filter cartridge 1. The air-permeable outer cage 3, preferably formed from perforated sheet metal, can be seen. The base disc 2 is located at the lower end of the outer cage 3. The inlet fitting 5 is attached at the upper end of the outer cage 3.

FIG. 4B shows a longitudinal section through the activated carbon filter cartridge 1 along a section plane A-A. The section plane A-A is drawn as a chain dotted line in FIG. 4A, The cylindrical outer cage 3, the conically tapering inner cage 4, and the activated carbon layer 6 disposed between the two can be seen in FIG. 4B. It can also be seen that the activated carbon layer 6 is thicker on the side facing the inlet fitting 5 than in the region of the base disc 2. The base disc 2 having the raised dome 9 is disposed at the lower end of the activated carbon filter cartridge 1. The inlet fitting 5 is attached at the upper end of the activated carbon filter cartridge 1.

FIG. 4C shows a plan view of the activated carbon filter cartridge 1. The cylindrical outer cage 3 and the inlet fitting 5 having the annular circumferential groove 11 can be seen.

FIG. 5 shows how the upper end of the conically tapered inner cage 4 is held in place by the circumferential groove 11. To this end, a region of the inlet fitting 5 is shown enlarged in detail. The upper end of the cylindrical outer cage 3, the upper end of the conically tapered inner cage 4, and the activated carbon layer 6 disposed between them can be seen. The inlet fitting 5 is placed on the upper end of the activated carbon filter cartridge so that the upper opening of the conically tapered inner cage 4 is slid over the annular circumferential groove 11. The upper opening of the inner cage 4 is thereby held and fixed in position by the annular circumferential groove 11. The upper edge of the outer cage 3 is then mechanically connected to the inlet fitting 5 by means of a plurality of blind rivets.

In the following, a further discussion of embodiments of the invention is provided.

Typically designed cartridge filters have a constant thickness of the activated carbon bed, which has the disadvantage that the airflow is greater on the suction side than the airflow at the base of the filter. This occurs because the pressure drop across the activated carbon arising from the airflow is determined by the thickness of the activated carbon bed. The activated carbon is not loaded to uniformly. An application in a large kitchen exhaust hood, for example, requires uniform airflow at the suction side and at the base of the filter in order to ensure constant exhausting of the kitchen vapors over the entire width above a deep fryer, for example. The following invention achieves the listed objects. Further applications include, for example, painting shops, butcher shops, toilets, animal pens, the animal feed industry, and everywhere that undesired odors occur.

According to a preferred embodiment, the activated carbon filter is characterized in that the perforated sheet metal inner cage thins out or conically tapers in the direction from the base disc toward the inlet fitting. The outer diameter of the cylindrical filter is characterized in that it is the same over the entire length. The activated carbon bed comprises a thickness of 5 cm on the suction side of the filter, for example, and of 4 cm at the base of the filter. Due to the shrinking thickness of the activated carbon in the direction of the base disc of the filter, the pressure drop also diminishes linearly, thus achieving a constant airflow.

The object of said embodiment is to provide an activated carbon air filter cartridge that allows fast assembly and disassembly, that can be refilled, that ensures maximum potential filter surface area in the minimum installed space, and that has uniform airflow over the entire area of the filter, in order to thereby uniformly load the activated carbon and ensure uniform exhausting.

According to a preferred embodiment, the assembly of the perforated sheet metal inner cage is characterized in that said cage is installed in the filter in a free-floating mariner arid is held in place by the groove on the inlet fitting. The fixation on the base disc of the filter is characterized in that the perforated inner cage is held in place by the deep-drawn dome on the base disc. The inlet fitting is attached to the perforated sheet metal outer cage by means of blind rivets. The base disc is spot welded to the outer cage.

The object of said embodiment is to design the perforated sheet metal inner cage so that said cage tapers conically, can be assembled without fasteners, ensures the same thickness of the activated carbon after assembly, and is easy to assemble and disassemble during the manufacturing process and when refilling.

1. A filter cartridge for cleaning air, comprising
a perforated sheet metal outer cage having a cylindrical shape, the diameter thereof being identical over the entire length of the filter cartridge,
a base disc closing off the filter cartridge at the lower end,
an inlet fitting closing off the filter cartridge at the upper end,
a conically shaped perforated sheet metal inner cage extending from the base disc to the inlet fitting in the interior of the perforated sheet metal outer cage and held in place by the base disc and the inlet fitting,
wherein the perforated sheet metal inner cage tapers conically in the direction from the base disc to the inlet fitting, and wherein the diameter of the perforated sheet metal inner cage continuously diminishes from the base disc toward the inlet fitting,
an activated carbon layer disposed in the intermediate space between the perforated sheet metal inner cage and the perforated sheet metal outer cage, wherein the thickness of the activated carbon layer diminishes in the direction from the inlet fitting to the base disc owing to the cylindrical shape of the perforated sheet metal outer cage and the conical shape of the perforated sheet metal inner cage.

2. The filter cartridge according to claim 1, characterized by at least one of the following:
the filter cartridge is designed such that air from the outside is drawn in through the activated carbon layer into the interior of the filter cartridge;
the filter cartridge is designed such that air from the interior of the filter cartridge is drawn off via the inlet fitting, wherein air from the outside is drawn through the activated carbon layer into the interior of the filter cartridge.

3. The filter cartridge according to claim 1, characterized in that the end of the perforated sheet metal inner cage comprising the smaller inner diameter is oriented toward the inlet fitting and the end of the perforated sheet metal inner cage comprising the larger inner diameter is oriented toward the base disc.

4. The filter cartridge according to claim 1, characterized by at least one of the following:
a pressure drop occurs along the activated carbon layer in the direction from the inlet fitting toward the base disc;
a linear pressure drop occurs along the activated carbon layer n the direction from the inlet fitting toward the base disc.

5. The filter cartridge according to claim 1, characterized in that the filter cartridge comprises a constant airflow over the entire activated carbon layer owing to the conical shape of the perforated sheet metal inner cage.

6. The filter cartridge according to claim 1, characterized by at least one of the following:
the perforated sheet metal outer cage is attached to the base disc by means of a plurality of spot welds;
the perforated sheet metal outer cage is attached to the inlet fitting by means of a plurality of blind rivets.

7. The filter cartridge according to claim 1, characterized by one of the following:
the base disc and the inlet fitting are each metal parts;
the base disc and the inlet fitting are each formed metal parts;
the base disc and the inlet fitting are formed by means of metal forming techniques;
the base disc and the inlet fitting are manufactured by means of high-performance spinning machines;
the base disc and the inlet fitting are each deep-drawn sheet metal parts.

8. The filter cartridge according to claim 1, characterized by at least one of the following:
the perforated sheet metal inner cage is installed in the filter cartridge in a free-floating manner;
the perforated sheet metal inner cage is disposed concentric to the outer cage in the interior of the perforated sheet metal outer cage;
the perforated sheet metal inner cage is held in place between the inlet fitting and the base disc in the interior of the perforated sheet metal outer cage;
the perforated sheet metal inner cage is supported at the lower end by the base disc and at the upper end by the inlet fitting;
the base disc and the inlet fitting are shaped such that the perforated sheet metal inner cage is held in place between the base disc and the inlet fitting;
the base disc comprises a deep-drawn dome in the center thereof, wherein the diameter of the deep-drawn dome corresponds approximately to the inner diameter at the lower end of the perforated sheet metal inner cage, wherein the lower end of the perforated sheet metal inner cage can he placed on the dome, and wherein the lower end of the perforated sheet metal inner cage can be held in place by the dome;
the inlet fitting comprises a circular circumferential groove, wherein the diameter of the groove corresponds approximately to the inner diameter of the perforated sheet metal inner cage at the upper end thereof, wherein the upper end of the perforated sheet metal inner cage can be placed on the circular circumferential groove, and wherein the upper end of the perforated sheet metal inner cage can be held in place by the circumferential groove.

9. The filter cartridge according to claim 1, characterized by at least one of the following:
the thickness of the activated carbon layer at the inlet fitting is about 5 cm;
the thickness of the activated carbon layer at the base disc is about 4 cm;
the filter cartridge comprises a length of about 50 cm;
the filter cartridge comprises a diameter of about 23 cm;
the filter cartridge comprises a length in the range of 30 cm to 70 cm;
the filter cartridge comprises a diameter in the range of 15 cm to 30 cm;
the inlet fitting has a diameter in the range of 8 cm to 20 cm.

10. A filter device for cleaning air, comprising:
a filter cartridge according to claim 1;
a suction blower, the air inlet thereof being releasably connected to the inlet fitting of the filter cartridge.

11. The filter device according to claim 10, characterized in that the suction blower is designed for drawing air from outside through the activated carbon layer into the interior of the filter cartridge.

12. The filter device according to claim 10, characterized in that the suction blower is designed for drawing air out through the inlet fitting from the interior of the filter cartridge, wherein air from the outside is drawn into the interior of the filter cartridge through the activated carbon layer.

13. The filter device according to claim 10, characterized in that the filter cartridge is a replaceable cartridge.

14. The filter device according to claim 10, characterized in that the filter device is provided for cleaning the air in at least one of the following: a large kitchen, a butcher's shop, a painting shop, toilets, animal pens, the animal feed industry.

15. A method for assembling a filter cartridge designed for cleaning air and made from
a cylindrical perforated sheet metal outer cage,
a base disc,
an inlet fitting, and
a perforated sheet metal inner cage, the shape of which tapers conically, the method comprising the following steps:
placing the perforated sheet metal outer cage on the base disc,
placing the upwardly conically tapering perforated sheet metal inner cage on the base disc,
introducing an activated carbon layer into the intermediate space between the perforated sheet metal inner cage and the perforated sheet metal outer cage;
sliding the inlet fitting onto the upper end of the perforated sheet metal inner cage and the perforated sheet metal outer cage, wherein the perforated sheet metal inner cage is held in place between the base disc and the inlet fitting.

16. The method according to claim 15, characterized by at least one of the following further steps:
attaching the perforated sheet metal outer cage to the base disc by means of a plurality of spot welds;
attaching the perforated sheet metal outer cage to the inlet fitting by means of a plurality of blind rivets.
